(19) United States
(12) Patent Application Publication
(10) Pub. No.: US 2026/0046206 A1
(43) Pub. Date: Feb. 12, 2026

(54) METHODS FOR CREATING AN INFRASTRUCTURE FOR A PLURALITY OF CLOUD PROVIDERS TO ENHANCE SERVICE RESILIENCY

(71) Applicant: Schlumberger Technology Corporation, Sugar Land, TX (US)

(72) Inventors: Kaustubh Patil, Pune (IN); Vijay Kumar, Pune (IN); Joji Lawrence M, Pune (IN)

(21) Appl. No.: 19/284,438

(22) Filed: Jul. 29, 2025

(30) Foreign Application Priority Data
Aug. 7, 2024 (IN) 202411059740

(51) Int. Cl. H04L 41/0823; H04L 47/125; H04L 61/4511

(52) U.S. Cl. CPC H04L 41/0823; H04L 47/125; H04L 61/4511

(57) ABSTRACT

A method for creating an infrastructure for a plurality of cloud providers includes receiving input data corresponding to the infrastructure for the plurality of cloud providers. The input data includes a plurality of deployments, a DNS zone including a single DNS name, and a global load balancer. The method also includes modifying a terraform configuration file based on the input data to define the infrastructure and thereby improve a distribution across the plurality of cloud providers. Modifying the terraform configuration file includes defining a respective path and respective deployment rules for each deployment of the plurality of deployments, defining the DNS zone and the single DNS name thereof, and defining one or more routing rules for the global load balancer. The method also includes creating the infrastructure based on the terraform configuration file to provide enhanced resiliency across the plurality of cloud providers.

### CROSS-REFERENCE TO RELATED APPLICATIONS

This application claims priority to India Patent Application No. 202411059740, filed on Aug. 7, 2024, which is incorporated by reference herein.

### BACKGROUND

Creating a resilient infrastructure across multiple cloud providers is often complex and time-consuming, involving extensive manual configuration and expertise. Existing solutions fail to offer a streamlined, automated approach for deploying and managing resilient services. This results in increased maintenance effort, higher chances of configuration errors, and inconsistent resiliency measures. Therefore, what is needed is a system and method that simplify this process by allowing users to provide input variables, with the system and method automatically setting up the entire resilient infrastructure, ensuring consistent and reliable service availability.

### SUMMARY

A method for creating an infrastructure for a plurality of cloud providers is disclosed. The method includes receiving input data corresponding to the infrastructure for the plurality of cloud providers. The input data includes a plurality of deployments, a DNS zone including a single DNS name, and a global load balancer. The method also includes modifying a terraform configuration file based on the input data to define the infrastructure and thereby improve a distribution across the plurality of cloud providers. Modifying the terraform configuration file includes defining a respective path and respective deployment rules for each deployment of the plurality of deployments, defining the DNS zone and the single DNS name thereof, and defining one or more routing rules for the global load balancer. The method also includes creating the infrastructure based on the terraform configuration file to provide enhanced resiliency across the plurality of cloud providers.

A computing system is also disclosed. The computing system includes one or more processors and a method system. The method system includes one or more non-transitory computer-readable media storing instructions that, when executed by at least one of the one or more processors, cause the computing system to perform operations for creating an infrastructure for a plurality of cloud providers. The operations include receiving input data corresponding to the infrastructure for the plurality of cloud providers. The input data includes a plurality of deployments, a DNS zone including a single DNS name, and a global load balancer. The operations also include modifying a terraform configuration file based on the input data to define the infrastructure and thereby improve a distribution across the plurality of cloud providers. Modifying the terraform configuration file includes defining a respective path and respective deployment rules for each deployment of the plurality of deployments, defining the DNS zone and the single DNS name thereof, and defining one or more routing rules for the global load balancer. The operations also include creating the infrastructure based on the terraform configuration file to provide enhanced resiliency across the plurality of cloud providers.

A non-transitory computer-readable medium is also disclosed. The medium stores instructions that, when executed by one or more processors of a computing system, cause the computing system to perform operations for creating an infrastructure for a plurality of cloud providers. The operations include receiving input data corresponding to the infrastructure for the plurality of cloud providers. The input data includes a plurality of deployments, a DNS zone including a single DNS name, and a global load balancer. The operations also include modifying a terraform configuration file based on the input data to define the infrastructure and thereby improve a distribution across the plurality of cloud providers. Modifying the terraform configuration file includes defining a respective path and respective deployment rules for each deployment of the plurality of deployments, defining the DNS zone and the single DNS name thereof, and defining one or more routing rules for the global load balancer. The operations also include creating the infrastructure based on the terraform configuration file to provide enhanced resiliency across the plurality of cloud providers.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a schematic view of a system for enhancing service resiliency, according to an embodiment.

FIG. 3 illustrates a schematic view of a workflow, according to an embodiment.

FIG. 4 illustrates a schematic view of a workflow, according to an embodiment.

FIG. 5 illustrates a flowchart of a method for enhancing resiliency across cloud providers, according to an embodiment.

FIG. 6 illustrates a flowchart of a method for preparing an infrastructure for a plurality of cloud providers, according to an embodiment.

FIG. 7 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

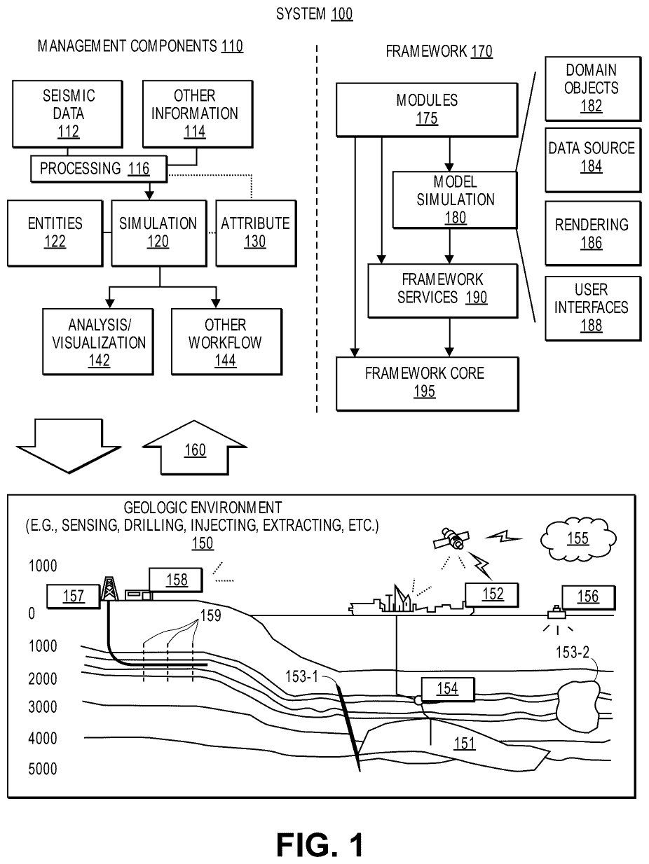

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Enhancing Service Resiliency Through Global Load Balancing and Cloud-Agnostic Backend Pool

In today's dynamic digital landscape, it would be beneficial to achieve improved service resiliency across multiple cloud providers and diverse backend technologies. The present disclosure presents a comprehensive approach to addressing this challenge through the integration of a global load balancer (GLB) and a cloud-agnostic backend pool. The present disclosure also addresses the intricacies of multi-cloud environments and provides a robust framework for implementing diverse deployment strategies.

Computer programs (e.g., software) such as DELFI® Petrotechnical Suite (PTS) may bring together a collection of digital solutions for petrotechnical workflows. They may be accessed from profiles covering the entire exploration and production (E&P) life cycle, which are hosted in the cloud and available on-demand. This means that solutions such as the PETREL® E&P software platform and INTERSECT® high-resolution reservoir simulator run with faster computing times, accessed anywhere, and include access to new tools increasing user flexibility and productivity.

The method described herein provides seamless integration of a global load balancer (GLB) and a cloud-agnostic backend pool. This solution accommodates a diverse array of services such as application programming interfaces (APIs), user interface (UI) components, and cloud storage. This also allows for deployment across multiple cloud providers and/or within private networks. A global load balancer with path-based routing (e.g., such as Azure Front Door (AFD)) may unify services under a single DNS name, simplifying administration and ensuring a resilient and scalable architecture.

A distinctive feature may be the support for multiple services deployed along unique URL paths. This decentralized deployment model enhances maintenance efficiency and facilitates the integration of disparate backend technologies. This inherent flexibility allows for seamless migration between backend technologies, establishing a foundation for a future-proof infrastructure. Organizations can leverage this architecture to coexist multiple deployments, each utilizing a different tech stack, providing unprecedented versatility.

In the implementation of the PTS project, this architecture may be augmented with active-standby deployment, utilizing AFD's capability to detect backend pool health and dynamically divert traffic accordingly. This strategic use of AFD enhances the resiliency of services by ensuring continuous availability and failover redundancy. Furthermore, the solution introduces support for various deployment strategies, including blue-green deployments for non-disruptive updates and canary deployments for controlled testing, tailoring deployment approaches to specific project objectives.

Moreover, the architecture is inherently scalable, adapting to the evolving digital services. The load balancing mechanism optimizes resource utilization, mitigating the risk of service degradation during peak usage. The incorporation of a cloud-agnostic backend pool adds an extra layer of resilience, enabling effortless transitions between cloud providers based on performance, cost, or other considerations.

Thus, the method may fortify services against disruptions and provide a versatile framework for implementing deployment strategies, making it helpful for organizations navigating the complexities of modern digital infrastructure.

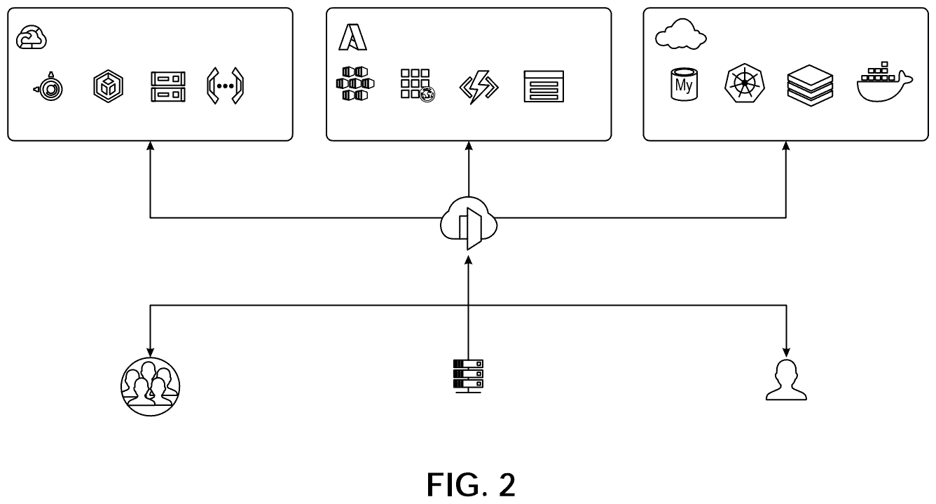

FIG. 2 illustrates a schematic view of a system or an infrastructure for enhancing service resiliency, according to an embodiment. The method is underscored by its support for multiple services deployed along unique URL paths, promoting a decentralized deployment model that enhances maintenance efficiency and facilitates the integration of disparate backend technologies. This inherent flexibility allows for seamless migration between backend technologies, establishing a foundation for a future-proof infrastructure. This provides the ability to coexist multiple deployments, each utilizing a different tech stack, provides unprecedented versatility.

One advantage is the provision, creation, generation, or otherwise preparation of a generic terraform deployment code. This codebase is designed to be versatile and easily adaptable, allowing organizations to deploy any number of services without modifying the code. The simplicity and generic nature of the code redefines how infrastructure is managed, providing a level of ease that transcends conventional complexities. Thus, the system and method may provide unified global load balancing and cloud-agnostic backend pool, generic terraform deployment code, tech stack versatility and coexistence, decentralized service deployment model, granular deployment strategies, or a combination thereof. The system and method may be or include a transformative tool that reshapes how organizations approach infrastructure management, offering practical benefits that extend beyond conventional solutions.

The system and method may provide and/or improve the availability of a versatile terraform deployment code. This codebase may be intentionally crafted to be adaptable and versatile, allowing organizations to deploy numerous services effortlessly without delving into code modifications. This inherent simplicity and adaptability redefine the landscape of infrastructure management, offering a level of ease that surpasses conventional complexities.

The solution may be presented in the form of code, simplifying the deployment process. The solution involves an update to the terraform configuration file, followed by the execution of the pipeline while providing the resource group details. The outcome is the deployment of a global load balancer for the project, complete with established routing rules and a singular URL to access the services. Furthermore, this solution facilitates the configuration of multiple stages and services within a single stage.

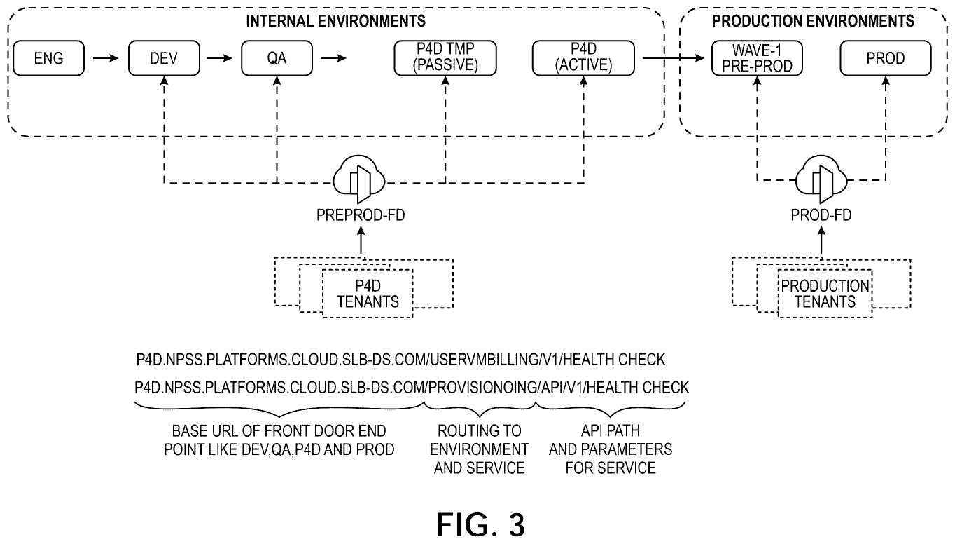

FIG. 3 illustrates a schematic view of a workflow, according to an embodiment. Beyond individual projects, the solution's generic nature allows organizations to adopt a standardized approach to deploying services. Teams can employ the same terraform codebase, ensuring consistency, reducing the learning curve, and streamlining infrastructure management practices on an organizational level. In addition, the solution's scalability and adaptability make it applicable to an organizational level and/or on a global scale. Projects worldwide can benefit from a standardized, efficient, and resilient infrastructure management approach.

The terraform code, terraform configuration code, or terraform configuration file may simplify the deployment process. The terraform configuration code may result in the generation of three distinct URLs for three different stages, each accessible through path-based routing:
1. dev.npss.platforms.cloud.slb-ds.com
2. p4d.npss.platforms.cloud.slb-ds.com
3. qa.npss.platforms.cloud.slb-ds.com

Moreover, this terraform configuration code ensures security through a web application firewall (WAF) configuration on the global load balancer. It supports custom domain association and simplifies the management of certificates for the associated domains.

The solution also leverages terraform workspaces, enabling organizations to configure and customize deployments at a scale. The ability to define distinct workspaces, stages, service-specific settings, and backend pool configurations ensures a tailored approach to deployment across various scenarios. This may create prod and non-prod two workspaces in PTS.

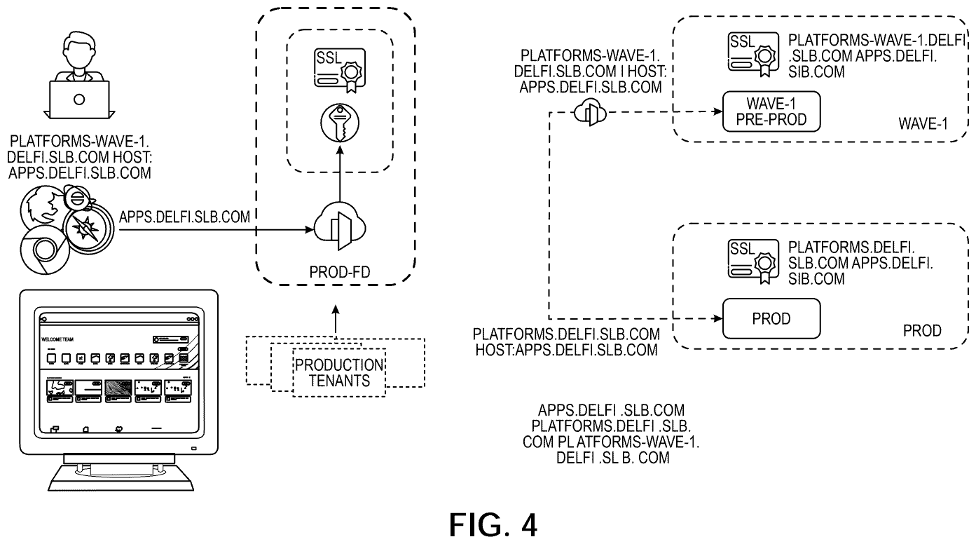

FIG. 4 illustrates a schematic view of a workflow, according to an embodiment. The terraform configuration file may define a source of a multidomain certificate. The multidomain certificate may be stored in at least one cloud provider of the plurality of cloud providers. For example, the multidomain certificate may be stored in each cloud provider of the plurality of cloud providers. Provisioning, creating, generating, or otherwise preparing the infrastructure based on the terraform configuration file may include attaching the multidomain certificate to a frontend of the global load balancer to associate a host header to one or more requests and secure the one or more requests directed from the frontend to the plurality of deployments hosted in the plurality of cloud providers. Each deployment may include the same multidomain certificate. The host for each deployment may be the same. Traffic through the infrastructure may be managed by a global load balancer according to the terraform configuration file. The multidomain certificate may allow traffic between the backend and the frontend while maintaining a host header.

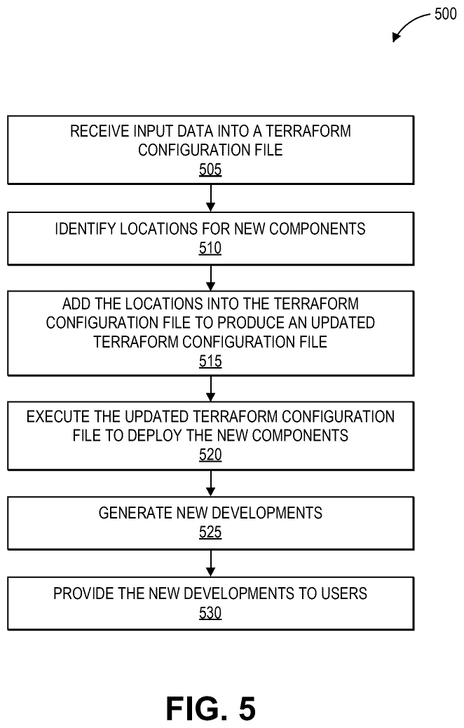

FIG. 5 illustrates a flowchart of a method for enhancing resiliency across cloud providers, according to an embodiment. An illustrative order of the method 500 is provided below; however, one or more portions of the method 500 may be performed in a different order, simultaneously, repeated, or omitted. At least a portion of the method 500 may be performed with a computing system 600 (described below).

The method 500 may include receiving input data into a terraform configuration file, as at 505. The input data may include existing deployments across different cloud providers.

The method 500 may also include identifying locations for new components, as at 510. This may provide or ensure optimal distribution across the cloud providers, thereby providing enhanced resiliency.

The method 500 may also include adding the locations into the terraform configuration file to produce an updated terraform configuration file, as at 515. This may enable automated and repeatable deployments.

The method 500 may also include executing the updated terraform configuration file to deploy the new components, as at 520. This may ensure consistency and reduce manual errors.

The method 500 may also include generating new developments as at 525. The new developments may be generated subsequent to the deployment of the new components. The new developments may include a global load balancer that provides efficient traffic management and failover capabilities. The new developments may also include a domain name that offers a unified access point for services. The new developments may also include firewall rules that enhance security by controlling access to the deployed new components. The new developments may also include a DNS zone that contains a domain name, wherein the DNS zone facilities updates and management of domain-related configurations.

The method 500 may also include providing the new developments to users, as at 530. The new developments may include the domain name, enabling the users to be unaffected by failures of backend components, thereby improving experiences of the users and service availability.

The method 500 may be configured for deployment in any server environment, ensuring flexibility and adaptability across diverse infrastructure setups.

The present disclosure may provide a plug-and-play global load balancer framework for multi-cloud resiliency driven by a terraform (e.g., a terraform code or a terraform configuration file). The terraform may be capable of or configured to standardize and/or simplify the deployment of globally resilient services across one or more cloud providers, one or more environments (e.g., Azure, GCP, on-premise, etc.), or a combination thereof. The present disclosure enables any product team to onboard their existing applications with minimal effort, ensuring enterprise-grade availability, performance, and security.

The terraform may be or include a highly modular, configuration-driven Terraform library, capable of provisioning and orchestrating one or more of the following: a global load balancer (e.g., Azure Front Door), an end-to-end TLS encryption and WAF security, smart traffic routing (e.g., round-robin, priority, latency-based, etc.), DNS records, and custom domains, certificates and secure key management, or any combination thereof. This may be achieved through a single, centralized configuration file (i.e., the terraform), that may enable one or more of the following: a dynamic service registration, multi-stage deployments (e.g., Dev, QA, Preprod, Prod), seamless multi-cloud support, centralized domain management and routing policies, or any combination thereof. The system may eliminate the need for hand-crafted scripts and/or cloud-specific expertise, thereby abstracting complexity behind a declarative interface.

The present disclosure may provide a one-time setup that may be a multi-use setup via a shared terraform module usable across teams and products. The present disclosure may be configurable and extensible to support custom routing logic, domains, and deployment stages. The present disclosure may provide zero app changes; and thus, may not require modification to existing backend services. The present disclosure may also be cloud-agnostic to work seamlessly across Azure, GCP, AWS, on-premises, or the like, or any combination thereof. The present disclosure may convert manual, error-prone infrastructure deployment into a streamlined declarative process, thereby setting a new standard for resilient architecture deployment. The present disclosure may globally expose and protect one or more services within a relatively shorter period of time as compared to conventional methods (e.g., hours vs weeks). The present disclosure may promote reusability, standardization, and governance via shared terraform modules, thereby reducing duplicated efforts and cloud sprawl. The present disclosure may avoid overprovisioning with dynamic backend scaling, thereby resulting in cost savings.

In view of the foregoing, the present disclosure may provide a plug-and-play global load balancer framework that may be more than just infrastructure automation. For example, the present framework may provide a strategic enabler for multi-cloud transformations. By abstracting complexity and embedding best practices into reusable modules, the present disclosure may empower teams to build resilient, secure, and scalable systems with minimal effort. This innovation demonstrates how infrastructure engineering may drive real business impact—by simplifying complexity, accelerating deployments, and fostering a culture of security, automation, and resilience across the organization.

The present disclosure may provide a framework or solution for the plurality of cloud services that is technology-agnostic and/or environmentally-agnostic. The present disclosure may support one or more of the following: services running on Azure (e.g., AKS, App services, etc.), workloads deployed in GCP (e.g., GAE, GKE, etc.), on-premise systems with public and/or private interfaces, mixed-mode deployments combining cloud and private infrastructure, or the like, or any combination thereof. The present disclosure provides flexibility that may ensure that teams may deploy and scale services wherever it makes the most business sense without sacrificing reliability or control. The present disclosure provides smart automation and/or intelligent infrastructure. The present disclosure may include an algorithm that may read input configuration and automatically provision one or more of the following: Azure Front Door profiles and routing rules, custom domains and DNS mappings, Key Vault entries and SSL certificates, WAF policies for perimeter protection, or any combination thereof. The present disclosure may intelligently associate services to routing rules and may further apply load-balancing strategies based on user intent that are declaratively defined in the terraform. The present disclosure may support both single-tenant and multi-tenant scenarios, as well as enterprise-scale blue-green deployments, canary deployments, or the like, or any combination thereof.

The design (e.g., the plug-and-play design) may be centered around an ease of adoption and reusability. New and/or existing applications may be onboarded or deployed by cloning the shared terraform repository, configuring a “.tfvars” file, and running standard terraform workflows. The “.tfvars” file may define and/or describe any one or more of the following: a number of stages, services and their respective backend targets, routing logic per service (e.g., priority-based, round robin, latency-aware, etc.), domain configurations (e.g., path-based routing or custom FQDN), or the like, or any combination thereof. The standard terraform workflow may include any one or more of the flowing: bash, CopyEdit, terraform plan, terraform apply, or any combination thereof. It should be appreciated that there may not be any need to rewrite application code and/or modify backend deployments. Accordingly, backend services, whether APIs or UIs, may be seamlessly registered and exposed via a unified global DNS endpoint with intelligent routing and failover capabilities.

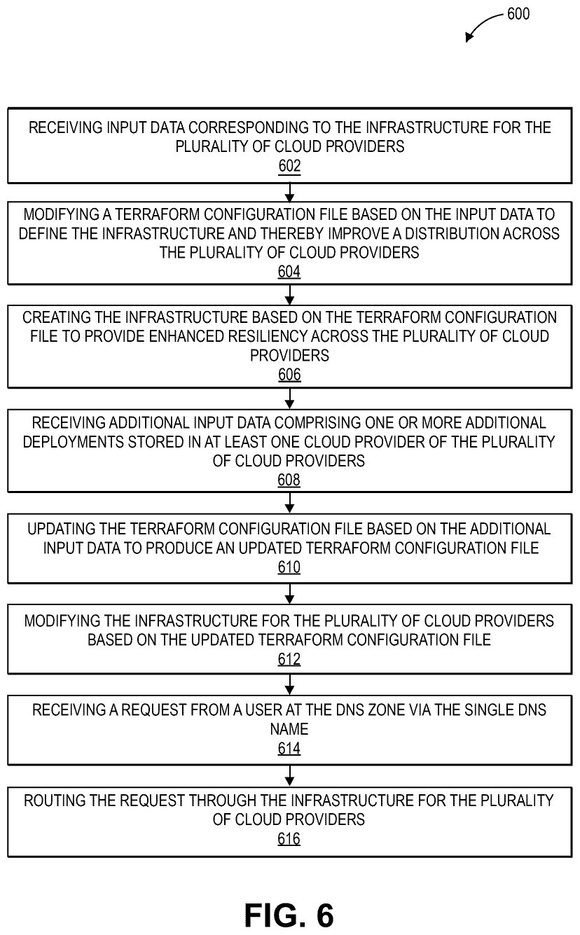

FIG. 6 illustrates flowchart of a method 600 for creating an infrastructure for a plurality of cloud providers, according to an embodiment. An illustrative order of the method 600 is provided below; however, one or more portions of the method 600 may be performed in a different order, simultaneously, repeated, or omitted. At least a portion of the method 600 may be performed using a computing system.

The method 600 may include receiving input data corresponding to the infrastructure for the plurality of cloud providers, as at 602. The method 600 may also include modifying a terraform configuration file based on the input data to define the infrastructure and thereby improve a distribution across the plurality of cloud providers, as at 604. The method 600 may further include creating the infrastructure based on the terraform configuration file to provide enhanced resiliency across the plurality of cloud providers, as at 606. The method 600 may also include receiving additional input data comprising one or more additional deployments stored in at least one cloud provider of the plurality of cloud providers, as at 608. The method 600 may also include updating the terraform configuration file based on the additional input data to produce an updated terraform configuration file, as at 610. The method 600 may also include modifying the infrastructure for the plurality of cloud providers based on the updated terraform configuration file, as at 612. The method 600 may also include receiving a request from a user at the DNS zone via the single DNS name, as at 614. The method 600 may also include routing the request through the infrastructure for the plurality of cloud providers, as at 616.

As noted above, the method 600 may include receiving input data corresponding to the infrastructure for the plurality of cloud providers, as at 602. The input data may include a plurality of deployments, a multidomain certificate, one or more domains, a DNS zone comprising a single DNS name, a global load balancer, a respective stage for each deployment of the plurality of deployments, or any combination thereof. Each deployment of the plurality of deployments may be hosted in at least one cloud provider of the plurality of cloud providers. Each deployment of the plurality of deployments may include one or more services. The multidomain certificate may be stored in at least one cloud provider of the plurality of cloud providers. In at least one example, the multidomain certificate may be stored in each cloud provider of the plurality of cloud providers. The plurality of deployments may include one or more of a UI application, an API server, a client-facing or frontend deployment, a backend or server-side deployment, an authentication service, a database, or the like, or any combination thereof. For example, the plurality of deployments may include any deployment and/or service accessible via a URL, either private or public.

As noted above, the method 600 may include modifying a terraform configuration file based on the input data to define the infrastructure and thereby improve a distribution across the plurality of cloud providers, as at 604. Modifying the terraform configuration file may include defining the plurality of deployments in the terraform configuration file. Modifying the terraform configuration file may also include defining a respective path for each deployment of the plurality of deployments. Modifying the terraform configuration file may further include defining respective deployment rules for each deployment of the plurality of deployments. Modifying the terraform configuration file may also include defining the respective stage for each deployment of the plurality of deployments. The respective stage may include a development stage, a pre-production for deployment stage, or a quality assurance stage. Modifying the terraform configuration file may also include defining the DNS zone and the single DNS name thereof. Modifying the terraform configuration file may also include defining one or more routing rules for the global load balancer. The one or more routing rules may include one or more of a path-based routing rule, a host-based routing rule, a header-based routing rule, a geolocation-based routing rule, an IP-based routing rule, a port-based routing rule, a weight-based routing rule, a health-based routing rule, or a combination thereof. The one or more routing rules may be configured to direct traffic for each deployment of the plurality of deployments through the DNS zone. The one or more routing rules may be configured to implement a load balancing logic for the global load balancer. The load balancing logic may be selected from a round robin logic, a priority-based logic, a latency-based logic, a health-based logic, a custom logic, a geolocation-based logic, a content-based logic, or a combination thereof. Modifying the terraform configuration file may also include defining a firewall configured to filter the traffic directed to the global load balancer. The firewall may include a web application firewall (WAF). Modifying the terraform configuration file may also include defining a source of the multidomain certificate.

As noted above, the method 600 may include creating the infrastructure based on the terraform configuration file to provide enhanced resiliency across the plurality of cloud providers, as at 606. Creating the infrastructure may include deploying the plurality of deployments. Creating the infrastructure may also include attaching the multidomain certificate to a frontend of the global load balancer to associate a host header to one or more requests and secure the one or more requests directed from the frontend to the plurality of deployments hosted in the plurality of cloud providers. The one or more requests may be directed from the frontend to the plurality of deployments based on the one or more domains defined in the global load balancer. Creating the infrastructure may further include creating the infrastructure based on the respective path for each deployment, the one or more routing rules for the global load balancer, the respective deployment rules for each deployment, or any combination thereof. Creating the infrastructure may also include associating the respective stage for each deployment of the plurality of deployments.

As noted above, the method 600 may include updating the terraform configuration file based on the additional input data to produce an updated terraform configuration file, as at 610. Updating the terraform configuration file based on the additional input data may include defining a respective path for each additional deployment of the one or more additional deployments. Updating the terraform configuration file may also include defining respective deployment rules for each deployment of the plurality of deployments. Updating the terraform configuration file may further include defining a respective stage for each additional deployment of the one or more additional deployments. The respective stage may include a development stage, a pre-production for deployment stage, or a quality assurance stage. Updating the terraform configuration file may also include defining one or more additional routing rules for the global load balancer. The one or more additional routing rules may include one or more of a path-based routing rule, a host-based routing rule, a header-based routing rule, a geolocation-based routing rule, an IP-based routing rule, a port-based routing rule, a weight-based routing rule, a health-based routing rule, or a combination thereof. The one or more additional routing rules may be configured to direct traffic for each additional deployment of the one or more deployments through the DNS zone.

The method 600 may also include modifying the infrastructure for the plurality of cloud providers based on the updated terraform configuration file, as at 612. Modifying the infrastructure based on the updated terraform configuration file may include deploying the additional plurality of deployments.

As noted above, the method 600 may further include routing the request through the infrastructure for the plurality of cloud providers, as at 616. Routing the request through the infrastructure may include resolving the single DNS name using the DNS zone to identify the frontend of the global load balancer. Routing the request through the infrastructure may also include directing the request to the frontend of the global load balancer. Routing the request through the infrastructure may further include authenticating the request using the multidomain certificate attached to the frontend of the global load balancer. Routing the request through the infrastructure may also include routing the request from the frontend to the plurality of cloud providers based on the infrastructure.

In at least one embodiment, the plurality of deployments may include a first deployment and a second deployment. The one or more routing rules of the terraform configuration file may be configured to implement a deployment strategy between the first deployment and the second deployment. The deployment strategy may include a blue-green deployment strategy, a canary deployment strategy, a rolling deployment strategy, an A/B testing deployment strategy, or a combination thereof.

The method 600 may also include displaying the terraform configuration file, the modified terraform configuration file, the infrastructure, or any combination thereof.

The method 600 may also include performing an action in response to creating the infrastructure or any step thereof disclosed herein. The action may be or include generating and/or transmitting a signal that recommends, instructs, or causes a physical action to occur. The physical action may be or include, but is not limited to, verifying the frontend or frontdoor domain to access one or more services, one or more deployments, or a combination thereof. The physical action may also be or include, but is not limited to, validating the SSL certificate for a UI application and/or service.

As noted above, the method 600 may include receiving a request from a user at the DNS zone via the single DNS name, as at 614, and routing the request through the infrastructure for the plurality of cloud providers, as at 616. The request from the user may be to access, utilize, execute, or otherwise run one or more deployments and/or services stored on at least one cloud provider of the plurality of cloud providers. The deployments and/or services may be or include a database (e.g., oil and gas database), a service or software (e.g., oil and gas service or software), an algorithm, a simulation, a model, or the like, or any combination thereof.

The method 600 may also include performing an action in response to running the one or more deployments and/or services stored on the at least one cloud provider of the plurality of cloud providers. For example, the one or more deployments and/or services may be or include, but are not limited to, one or more oil and gas services or programs stored in the at least one cloud provider of the plurality of cloud providers. The action may be or include generating and/or transmitting a signal that recommends, instructs, or causes a physical action to occur in response to running the oil and gas services or programs. For example the physical action may be or include, but is not limited to, a wellsite action. The wellsite action may be based upon or in response to the oil and gas services or programs requested or run by the user. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Exemplary Computing System

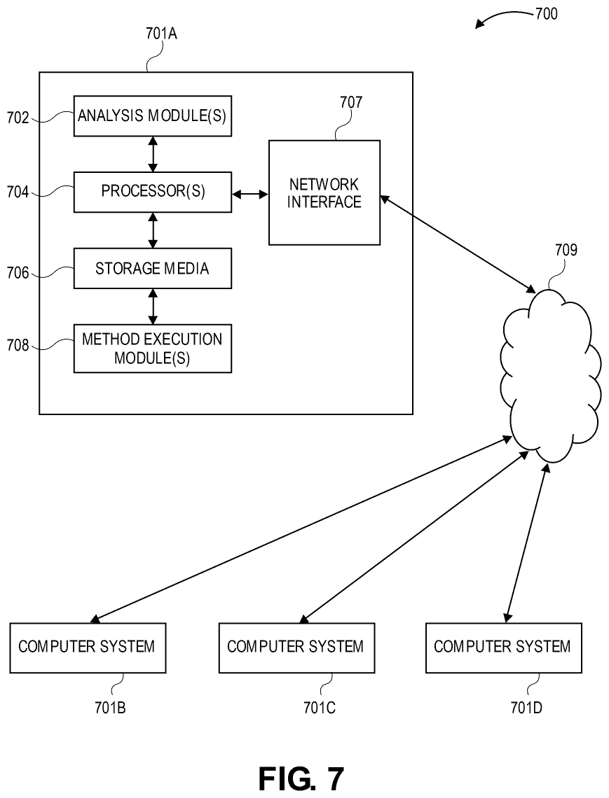

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more method execution module(s) 708. In the example of computing system 700, computer system 701A includes the method execution module 708. In some embodiments, a single method execution module may be used to perform some aspects of one or more embodiments of the methods disclosed herein. In other embodiments, a plurality of method execution modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for creating an infrastructure for a plurality of cloud providers, the method comprising:
receiving input data corresponding to the infrastructure for the plurality of cloud providers, wherein the input data comprises a plurality of deployments, a DNS zone comprising a single DNS name, and a global load balancer;
modifying a terraform configuration file based on the input data to define the infrastructure and thereby improve a distribution across the plurality of cloud providers, wherein modifying the terraform configuration file comprises:
defining a respective path and respective deployment rules for each deployment of the plurality of deployments;
defining the DNS zone and the single DNS name thereof; and
defining one or more routing rules for the global load balancer; and
creating the infrastructure based on the terraform configuration file to provide enhanced resiliency across the plurality of cloud providers.

2. The method of claim 1, wherein the one or more routing rules are configured to direct traffic for each deployment of the plurality of deployments through the DNS zone.

3. The method of claim 1, wherein the one or more routing rules are configured to implement a load balancing logic for the global load balancer, and wherein the load balancing logic is selected from a round robin logic, a priority-based logic, a latency-based logic, a health-based logic, a custom logic, a geolocation-based logic, a content-based logic, or a combination thereof.

4. The method of claim 1, wherein the input data further comprises a multidomain certificate stored in at least one cloud provider of the plurality of cloud providers.

5. The method of claim 4, wherein modifying the terraform configuration file further comprises defining a source of the multidomain certificate; and wherein creating the infrastructure comprises attaching the multidomain certificate to a frontend of the global load balancer.

6. The method of claim 1, wherein the input data further comprises a respective stage for each deployment of the plurality of deployments, wherein modifying the terraform configuration file further comprises defining the respective stage for each deployment of the plurality of deployments, and wherein the respective stage comprises a development stage, a pre-production for deployment stage, or a quality assurance stage.

7. The method of claim 1, further comprising:
receiving additional input data comprising one or more additional deployments stored in at least one cloud provider of the plurality of cloud providers;
updating the terraform configuration file based on the additional input data to produce an updated terraform configuration file; and
modifying the infrastructure for the plurality of cloud providers based on the updated terraform configuration file.

8. The method of claim 1, wherein the plurality of deployments comprise a first deployment and a second deployment, and wherein the one or more routing rules of the terraform configuration file are configured to implement a deployment strategy between the first deployment and the second deployment.

9. The method of claim 1, further comprising displaying the terraform configuration file, the updated terraform configuration file, the infrastructure, a service stored in the plurality of cloud providers, a database stored in the plurality of cloud providers, or a combination thereof.

10. The method of claim 9, further comprising:
routing the request through the infrastructure for the plurality of cloud providers;
operating at least one deployment of the plurality of deployments in response to routing the request through the infrastructure, wherein the at least one deployment comprises an oil and gas service; and
performing a wellsite action in response to operating the at least one deployment of the plurality of deployments, wherein performing the wellsite action comprises generating and/or transmitting a signal that recommends, instructs, or causes a physical action to occur, and wherein the physical action comprises one or more of selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or a combination thereof.

11. A computing system, comprising:
one or more processors; and
a memory system comprising one or more non-transitory computer-readable media storing instructions that, when executed by at least one of the one or more processors, cause the computing system to perform operations for creating an infrastructure for a plurality of cloud providers, the operations comprising:
receiving input data corresponding to the infrastructure for the plurality of cloud providers, wherein the input data comprises a plurality of deployments, a DNS zone comprising a single DNS name, and a global load balancer;
modifying a terraform configuration file based on the input data to define the infrastructure and thereby improve a distribution across the plurality of cloud providers, wherein modifying the terraform configuration file comprises:
defining a respective path and respective deployment rules for each deployment of the plurality of deployments;
defining the DNS zone and the single DNS name thereof; and
defining one or more routing rules for the global load balancer; and
creating the infrastructure based on the terraform configuration file to provide enhanced resiliency across the plurality of cloud providers.

12. The computing system of claim 11, further comprising:
receiving additional input data comprising one or more additional deployments stored in at least one cloud provider of the plurality of cloud providers;
updating the terraform configuration file based on the additional input data to produce an updated terraform configuration file, wherein updating the terraform configuration file comprises:
defining a respective stage for each additional deployment of the one or more additional deployments; and
modifying the infrastructure for the plurality of cloud providers based on the updated terraform configuration file.

13. The computing system of claim 11, wherein the one or more routing rules comprise one or more of a path-based routing rule, a host-based routing rule, a header-based routing rule, a geolocation-based routing rule, an IP-based routing rule, a port-based routing rule, a weight-based routing rule, a health-based routing rule, or a combination thereof.

14. The computing system of claim 11, wherein modifying the terraform configuration file further comprises defining a firewall configured to filter traffic directed to the global load balancer, wherein the firewall comprises a web application firewall (WAF).

15. The computing system of claim 11, wherein creating the infrastructure based on the terraform configuration file comprises:
deploying the plurality of deployments; and
creating the infrastructure based on the respective path for each deployment, the one or more routing rules for the global load balancer.

16. A non-transitory computer-readable medium storing instructions that, when executed by one or more processors of a computing system, cause the computing system to perform operations for creating an infrastructure for a plurality of cloud providers, the operations comprising:
receiving input data corresponding to the infrastructure for the plurality of cloud providers, wherein the input data comprises a plurality of deployments, a DNS zone comprising a single DNS name, and a global load balancer;
modifying a terraform configuration file based on the input data to define the infrastructure and thereby improve a distribution across the plurality of cloud providers, wherein modifying the terraform configuration file comprises:
defining a respective path and respective deployment rules for each deployment of the plurality of deployments;
defining the DNS zone and the single DNS name thereof; and
defining one or more routing rules for the global load balancer; and
creating the infrastructure based on the terraform configuration file to provide enhanced resiliency across the plurality of cloud providers.

17. The non-transitory computer-readable medium of claim 16, further comprising:
receiving a request from a user at the DNS zone via the single DNS name; and
routing the request through the infrastructure for the plurality of cloud providers, wherein the one or more routing rules are configured to route the request through the DNS zone.

18. The non-transitory computer-readable medium of claim 17, wherein routing the request through the infrastructure comprises:
resolving the single DNS name using the DNS zone to identify a frontend of the global load balancer;
directing the request to the frontend of the global load balancer; and
routing the request from the frontend to the plurality of cloud providers based on the infrastructure.

19. The non-transitory computer-readable medium of claim 18, wherein:
the input data further comprises a multidomain certificate stored in each cloud provider of the plurality of cloud providers;
modifying the terraform configuration file further comprises defining a source of the multidomain certificate;
creating the infrastructure further comprises attaching the multidomain certificate to the frontend of the global load balancer; and
routing the request through the infrastructure further comprises authenticating the request using the multidomain certificate attached to the frontend of the global load balancer.

20. The non-transitory computer-readable medium of claim 16, wherein the plurality of deployments comprise a first deployment and a second deployment, and wherein the one or more routing rules of the terraform configuration file are configured to implement a deployment strategy between the first deployment and the second deployment, and wherein the deployment strategy comprises a blue-green deployment strategy, a canary deployment strategy, a rolling deployment strategy, an A/B testing deployment strategy, or a combination thereof.
